(19) United States
(12) Patent Application Publication
(10) Pub. No.: US 2002/0015256 A1
(43) Pub. Date: Feb. 7, 2002

(54) Spindle motor and floppy disk device using the same

(75) Inventors: Masahiko Kadokura, Sagamihara-shi (JP); Hiroshi Nishizawa, Yokohama (JP); Hisashi Sakogawa, Tokyo (JP)

Correspondence Address: McDERMOTT, WILL & EMERY, 600 13th Street, N.W., Washington, DC, 20005-3096, US

(73) Assignee: MATSUSHITA ELECTRIC INDUSTRIAL CO., LTD.

(21) Appl. No.: 09/837,451

(22) Filed: Apr. 19, 2001

(30) Foreign Application Priority Data
Aug. 4, 2000 (JP) 2000-237541

(51) Int. Cl. G11B 17/02

(52) U.S. Cl. 360/99.04

(57) ABSTRACT

An improved structure of a spindle motor for use in a floppy disk device is provided. The spindle motor includes a stator and a radial bearing. The stator is made of a magnetic metal plate on which an electric circuit is provided and in which a bearing mount hole is formed. The radial bearing supports a spindle and includes a mounting outer wall fitted within the bearing mount hole of the stator and a bearing wall taking a radial load acting on the spindle. A groove is formed in the radial bearing between the mounting outer wall and the bearing wall to absorb the stress produced upon installation of the radial bearing which may cause the bearing wall to be deformed undesirably.

### BACKGROUND OF THE INVENTION

1. Technical Field of the Invention

The present invention relates generally to a spindle motor for use in external storage devices such as personal computers and a floppy disk device using the same, and more particularly to an improved structure of a spindle motor designed to rotate with minimized axial deflection and a floppy disk device using the same.

2. Background Art

Japanese Patent First Publication No. 7-21676 discloses a spindle motor designed for achieving a reduction in thickness of a floppy disk device.

FIG. 9 shows an example of such a spindle motor.

A spindle motor 900 is fabricated by fitting a radial bearing 920 supporting a spindle 910 into a mount hole 930b formed in a metal-made magnetic plate 930 from the side of a surface 930a of the magnetic plate 930 and staking a protrusion 920a formed on the radial bearing 920 so that it may lie flush with a bottom surface 930c of the magnetic plate 930.

The radial bearing 920 has a chamfered surface 920b to define a groove whose depth 921 is substantially equal to a thickness 931 of the magnetic plate 930, thereby avoiding a reduction in inner diameter 922 of the radial bearing 920 caused by the staking of the protrusion 920a.

The formation of the chamfered surface 920b on the radial bearing 920, however, results in a decrease in bearing span 923 of the radial bearing 920 as compared with a case where the chamfered surface 920b is not formed on the radial bearing 920, which will cause the degree of axial deflection of a spindle 910 to increase undesirably. The axial deflection will contribute to eccentric motion of a track of a magnetic storage disk or floppy disk fitted on the spindle 910, thus resulting in difficulty in compatibility of the floppy disk device using the spindle motor 900.

It is possible for the spindle motor 900 to avoid the increase in axial deflection of the spindle 910 by increasing the bearing span 923, however, it requires decreasing a clearance between a bearing wall 920c of the radial bearing 920 and a peripheral wall of the spindle 910, which will cause the friction therebetween to increase, thus resulting in an increase in consumption of power of the spindle motor 900.

The decrease in clearance between the bearing wall 920c of the radial bearing 920 and the peripheral wall of the spindle 910 may also cause the inner diameter 922 of the radial bearing 920 to have different values in a circumferential direction due to the deformation of the bearing wall 920c resulting from the stress produced by the staking of the protrusion 920, thereby leading to an increase in load on the spindle 910 during rotation. In order to avoid this drawback, control of the inner diameter 922 of the radial bearing 920 such as a sizing operation becomes necessary, but it results in a decrease in production yield.

### SUMMARY OF THE INVENTION

It is therefore a principal object of the invention to avoid the disadvantages of the prior art.

It is another object of the invention to provide a compact structure of a floppy disk device and an improved structure of a spindle motor which enables a spindle to rotate with a minimized degree of axial deflection without increasing a load on the spindle and which allows the thickness of the floppy disk device to be increased.

According to one aspect of the invention, there is provided a spindle motor which may be used in a floppy driver. The spindle motor comprises: (a) a spindle; (b) a stator made of a magnetic metal plate on which an electric circuit is provided and in which a bearing mount hole is formed; (c) a radial bearing supporting the spindle in a radial direction thereof, the radial bearing including a mounting portion fitted within the bearing mount hole of the stator and a bearing wall taking a radial load acting on the spindle; and (d) a groove formed in the radial bearing between the mounting portion and the bearing wall for absorbing the stress produced by installation of the radial bearing in the stator during assembly of the floppy disk device, thereby ensuring the roundness of the bearing wall.

In the preferred mode of the invention, the magnetic metal plate is made of a non-oriented silicon steel plate.

The magnetic metal plate has an edge of the bearing mount hole curved to define a recess between the edge and a periphery of the mounting portion of the radial bearing. The radial bearing has formed thereon a protrusion which is staked into the recess of the magnetic metal plate.

The depth of the groove is greater than or equal to the thickness of the magnetic metal plate.

The radial bearing is made of a copper-based oil impregnated metal.

The spindle motor further comprises a rotor having formed therein a hole in which the spindle is press-fitted directly.

The spindle motor further comprises a ball thrust bearing disposed outside the bearing wall of the radial bearing to take thrust acting thereon. The center of each ball of the ball thrust bearing is located between an upper and a lower end of the bearing wall.

According to the second aspect of the invention, there is provided a floppy disk device which comprises: a base plate and a spindle motor disposed on the base plate for rotating a floppy disk. The spindle motor includes (a) a spindle, (b) a stator made of a magnetic metal plate on which an electric circuit is provided and in which a bearing mount hole is formed, (c) a radial bearing supporting the spindle in a radial direction thereof, the radial bearing including a mounting portion fitted within the bearing mount hole of the stator and a bearing wall taking a radial load acting on the spindle, and (d) an annular groove formed in the radial bearing between the mounting portion and the bearing wall for absorbing the stress produced by installation of the radial bearing in the stator during assembly of the floppy disk device, thereby ensuring the roundness of the bearing wall.

In the preferred mode of the invention, the magnetic metal plate is made of a non-oriented silicon steel plate.

The magnetic metal plate has an edge of the bearing mount hole curved to define a recess between the edge and a periphery of the mounting portion of the radial bearing. The radial bearing has formed thereon a protrusion which is staked into the recess of the magnetic metal plate.

The depth of the groove is greater than or equal to a thickness of the magnetic metal plate.

The radial bearing is made of a copper-based oil impregnated metal.

The floppy disk device further comprises a rotor having formed therein a hole in which the spindle is press-fitted directly.

The floppy disk device further comprises a ball thrust bearing disposed outside the bearing wall of the radial bearing to take thrust acting thereon. The center of each ball of the ball thrust bearing is located between an upper and a lower end of the bearing wall.

According to the third aspect of the invention, there is provided a floppy disk device which comprises: (a) a rotor; (b) a chuck disposed on the rotor; (c) a spindle press-fitted directly in the rotor; (d) a stator made of a magnetic metal plate on which an electric circuit is provided and in which a bearing mount hole is formed; (e) a radial bearing supporting the spindle in a radial direction thereof, the radial bearing including a mounting portion fitted within the bearing mount hole of the stator and a bearing wall taking a radial load acting on the spindle; and (f) an annular groove formed in the radial bearing between the mounting portion and the bearing wall for absorbing the stress produced by installation of the radial bearing in the stator during assembly of the floppy disk device, thereby ensuring the roundness of the bearing wall.

### BRIEF DESPCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a perspective view which shows a spindle motor according to the present invention;

FIG. 2 is a perspective view which shows a rotor yoke of the spindle motor of FIG. 1;

FIG. 3 is a partial sectional view which shows a spindle motor;

FIG. 4 is a plan view which shows a floppy disk device equipped with the spindle motor of FIG. 1;

FIG. 5 is an exploded perspective view which shows a floppy disk device;

FIG. 6 is a perspective view which shows a floppy disk to be loaded into the floppy disk device of FIGS. 4 and 5;

FIG. 7 is a perspective view which shows a magnetic disk disposed within a housing as shown in FIG. 6;

FIG. 8 is a graph which shows a relation between a decrease in inner diameter of a bearing wall and the height of a protrusion to be deformed plastically by staking for different depths of a slit obtained by tests; and

FIG. 9 is a partial sectional view which shows a conventional floppy disk device.

### DESCRIPTION OF THE PREFERRED EMBODIMENTS

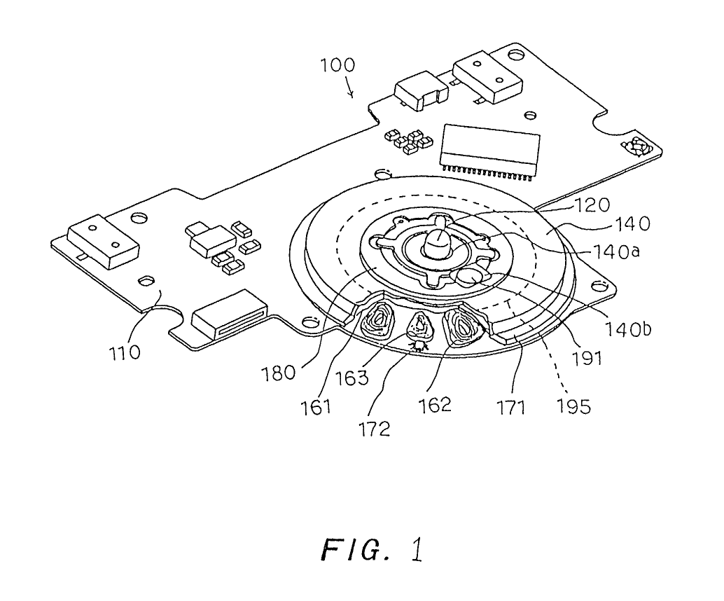

Referring to the drawings, wherein like reference numbers refer to like parts in several views, particularly to FIGS. 1 to 3, there is shown a spindle motor 100 according to the present invention.

The spindle motor 100 includes a silicon printed-circuit board 110 which is formed by sticking an insulating layer 112 and copper foil 113 on a non-oriented silicon steel plate 111 having a thickness of 0.5 mm with adhesive. The printed-circuit board 110 has a bearing mount hole 110a formed by punching it from an outer surface (i.e., the bottom) of the steel plate 111 to the copper foil 113. A round surface 110b is also formed around the periphery of the mount hole 110a by the punching. The spindle motor 100 is of a axial-gap type. The printed-circuit board 110 also serves as a magnetic chassis and a stator or back yoke constituting a magnetic circuit.

The spindle motor 100 includes a spindle 120 and a radial bearing 130. The radial bearing 130 has a bearing wall 130a which supports the spindle 120 rotatably. The spindle 120 is made of a 4 mm dia. stainless steel bar (e.g., SUS-420J2) which is subjected to quench-and-temper and polishing to have a given hardness and shape. The radial bearing 130 is made of a copper-based oil impregnated metal (e.g., a low-temperature sintered metal produced by Nippon Kagaku Yakin Co., Ltd.) for facilitating the initial conformability with the spindle 120, ease of caulking or staking in view of a harness difference between itself and the spindle 120. A lubricant impregnated into the radial bearing 130 contains an extreme-pressure additive (known as E.P. additive) for increasing the service lift of the radial bearing 130.

The radial bearing 130 has a disc portion 130b, an annular protrusion 130c, an annular recess 130d, an annular groove 130e on which a thrust bearing 150, as will be described later in detail, is disposed and an annular strip-like groove or slit 130f. The cylindrical disc portion 130b is fitted within the mount hole 110a in the printed-circuit board 110. The annular protrusion 130c is staked in an assembling process of the spindle motor 100 to secure the radial bearing 130 in the mount hole 130c firmly. The annular recess 130d works to receive a turned-up edge of the mount hole 110a (i.e., a burr) after the punching for ensuring firm attachment of the radial bearing 130 to the printed-circuit board 110 by the staking of the protrusion 130c on the round surface 110b. The annular slit 130f extends between the bearing wall 130a and the protrusion 130c and is formed during molding of a body of the radial bearing 130 using a metal mold so as to have a width of 0.3 mm and a depth of 0.6 mm greater than the thickness of the printed-circuit board 110.

The spindle motor 100 includes a rotor yoke 140 which has a burring hole 140a formed in a central portion thereof into which the spindle 120 is press-fitted and a hole 140b formed at a given distance from the center by a given distance out of which a drive pin 191 is movable. The rotor yoke 140 is retained by the spindle 120 by the press-fit of the spindle 120 into the burring hole 140a. The rotor yoke 140 is made by pressing a galvanized sheet iron (e.g., SECC) having a thickness of 0.6 mm.

The spindle motor 100 also includes the thrust bearing 150, as described above, which consists of a mount plate 151 disposed on the annular groove 130e of the radial bearing 130, a rotary plate 152 rotatable relative to the radial bearing 130 together with the rotor yoke 140, twelve balls 152 disposed between the mount plate 151 and the rotary plate 152, and a retainer 154 for the balls 152. The thrust bearing 150 works to take an axial load on the rotor yoke 140. Each of the balls 153 is made of a chrome steel (SUJ-2) having a diameter of approximately 1.6 mm (1/16″ ). The mount plate 151 and the rotary plate 152 is made of an SK steel subjected to the quench and polishing. SRL grease that is Li soap-based grease is used as the lubricant for the thrust bearing 150.

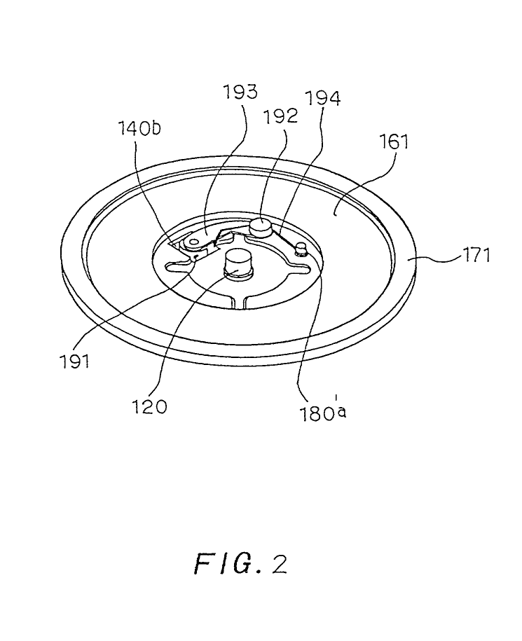

The spindle motor 100 also includes a main magnet 161 and coils 162 and 163, as shown in FIGS. 1 and 2. The main magnet 161 is installed on the bottom of the rotor yoke 140 and has neodymium boron iron (Nd—Fe—B)-made sintered magnets to provide sixteen magnetic poles on a surface thereof. Each of the coils 162 and 163 is made of a ribbon of wire which is square in cross section for increasing the space factor thereof. The main magnet and the coils 162 and 163 work to produce torque which induces the rotor yoke 140 to rotate relative to the printed-circuit board 110. The magnetic poles of the main magnet 161 are short-circuited magnetically by a contact surface (i.e., the bottom surface) of the rotor yoke 140. The thrust bearing 150 takes a vertical load produced by an attractive force of approximately 25N (2.6 kgf) from the main magnet 161.

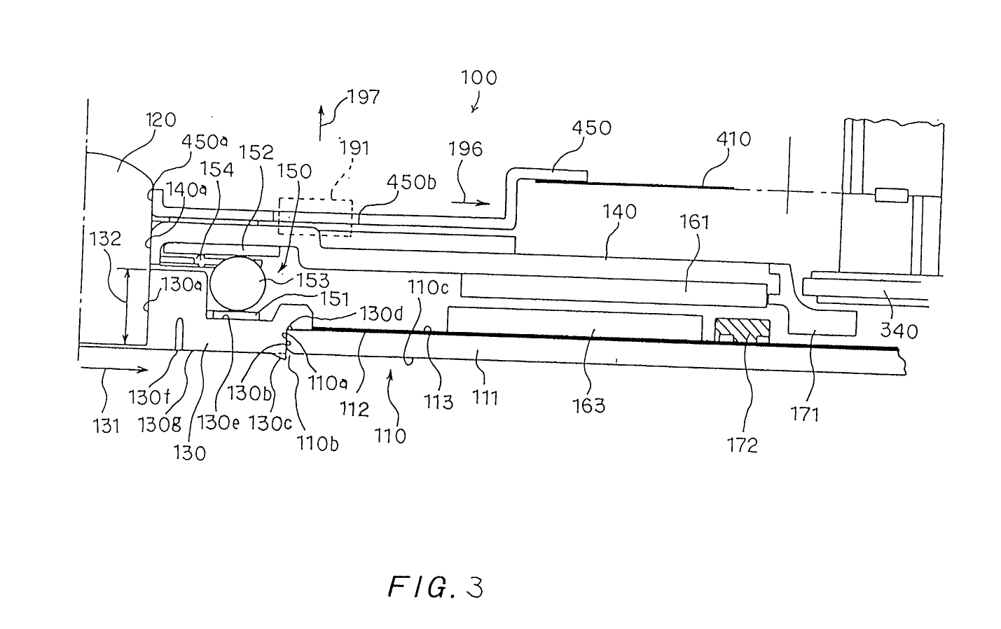

The spindle motor 100 also includes an FG (Frequency Generator) magnet 171 and a Hall element 172. The FG magnet 171 is installed on the periphery of the rotor yoke 140 and has 120 magnetic poles. The Hall element 172 is, as clearly shown in FIG. 3, installed on the printed-circuit board 110 which monitors an angular position of the magnet 171 (i.e., the main magnet 161) to produce a signal indicative thereof. The FG magnet 171 is a ferrite plastic magnet formed using polyamide as binder.

The spindle motor 100 also includes, as shown in FIG. 1, hub magnet 180 which is installed on the rotor yoke 140. The hub magnet 180 is made of a ferrite plastic magnet formed using polyamide as binder and works to attract a metal center core of the floppy disk, as will be described later.

The spindle motor 100 also includes the drive pin 191 working to transmit the torque to the magnetic storage medium or floppy disk. The drive pin 191 is staked on an end of a hub spring 193 which is retained pivotably by a drive shaft 192. The hub spring 193 is urged by a P-spring 194 to thrust the drive pin 191 away from the spindle 120 (i.e., a direction as indicated by an arrow 196 in FIG. 3) and the printed-circuit board 110 (i.e., a direction as indicated by an arrow 197 in FIG. 3). The P-spring 194 is made of a wire spring installed at one end on a boss 180a formed on the hub magnet 180. The drive pin 191 is made of a material NT-910 produced by Nippon Kagaku Yakin Co., Ltd. which is subjected to compression, baking, and quench-and-temper and into which lubricant is impregnated. The drive pin 191 has a hardness of 200 to 400 Hv for minimizing the wear and facilitating the ease of staking. The drive shaft 192 is made of a stainless steel (SUS303). The hub spring 193 is made of a phosphor bronze plate having a thickness of 0.15 mm. The P-spring 194 is made of a heat-treated stainless steel (SUS304) plate. The chuck 195 is made up of the hub magnet 180, the drive pin 191, the hub spring 193, the drive shaft 192, and the P-spring 194 disposed on the rotor yoke 140 and works to grip the floppy disk.

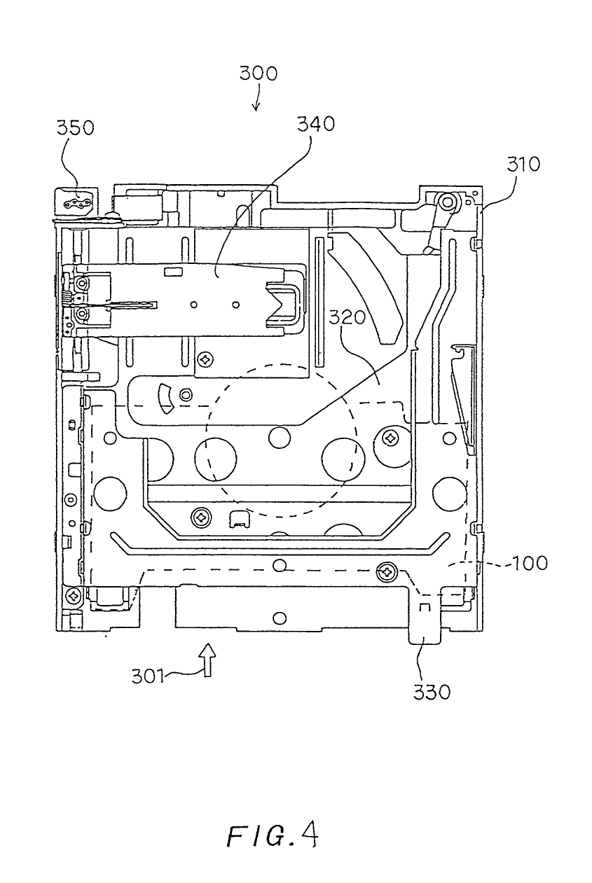

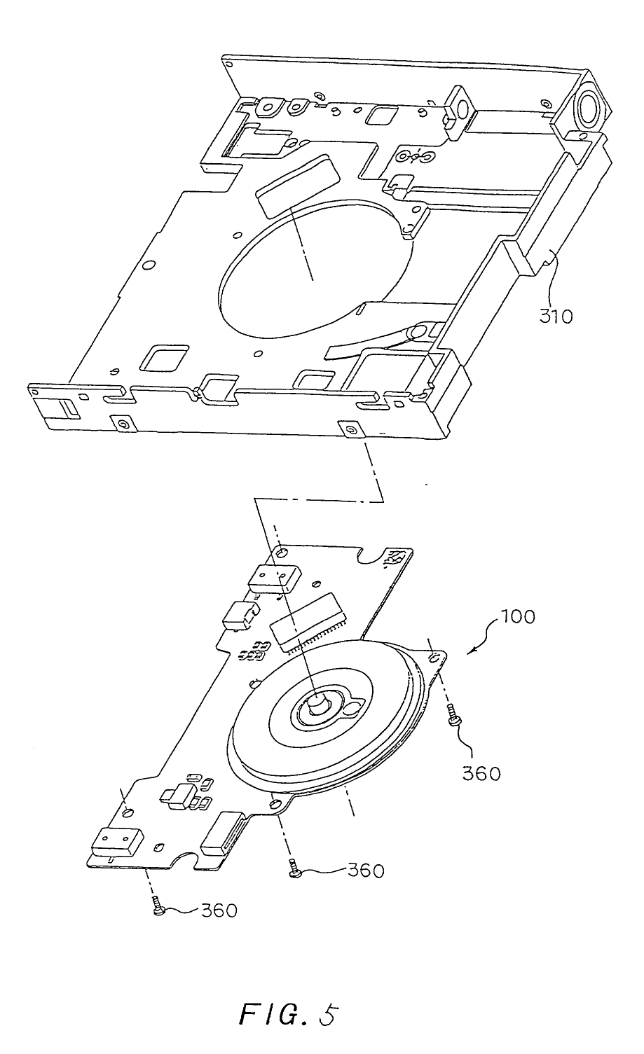

FIGS. 4 and 5 show a floppy disk device (i.e., disk drive) 300 equipped with the spindle motor 100 as described above.

The floppy disk device 300 also includes a base plate 310, a holder 320, an ejector lever 330, a head carriage assembly 340, and a step motor 350. The head carriage assembly 340 has a magnetic head disposed on its tip. The step motor 350 moves the head carriage assembly 340. The floppy disk is loaded into the floppy disk device 300 from a direction as indicated by an arrow 301. Upon loading of the floppy disk, the floppy disk device 300 moves the magnetic head installed in the head carriage assembly 340 to a given track on the floppy disk for recording or reproducing data. The spindle motor 100 is, as clearly shown in FIG. 5, installed on the base plate 310 using screws 360.

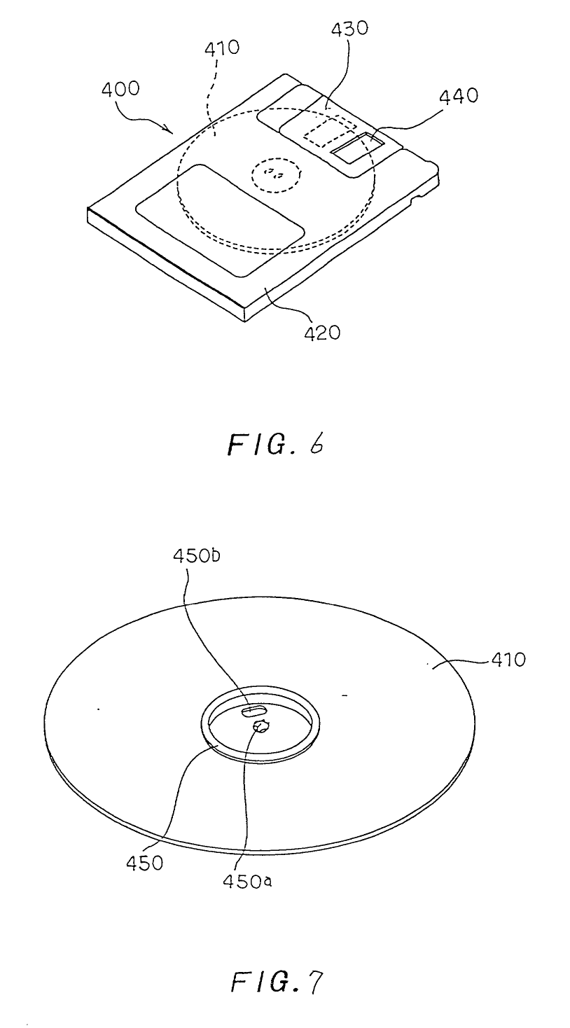

FIG. 6 shows the floppy disk 400 to be loaded into the floppy disk device 300. The floppy disk 400 is a 3.5″ floppy disk prescribed in JIS. X-6223 which consists of a body 400 (referred to below as a cookie) made of a film such as PET coated on both sides with magnetic material, a plastic casing 420 in which the cookie 410 is disposed, and a slidable shutter 430 installed on the casing 420. The casing 420 and the shutter 430 have windows 440 through which the cookies 410 is held at both sides thereof for recording or reproducing data on or from the cookie 410.

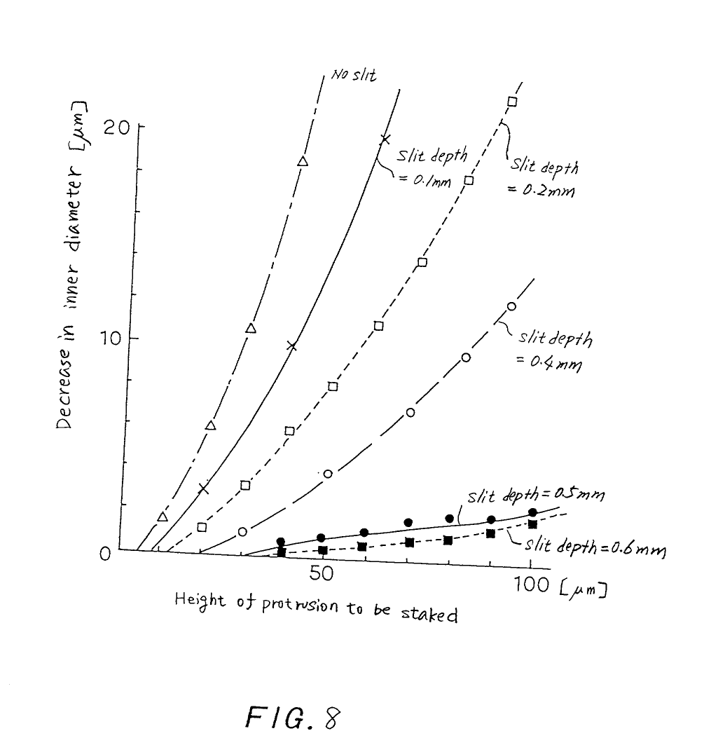

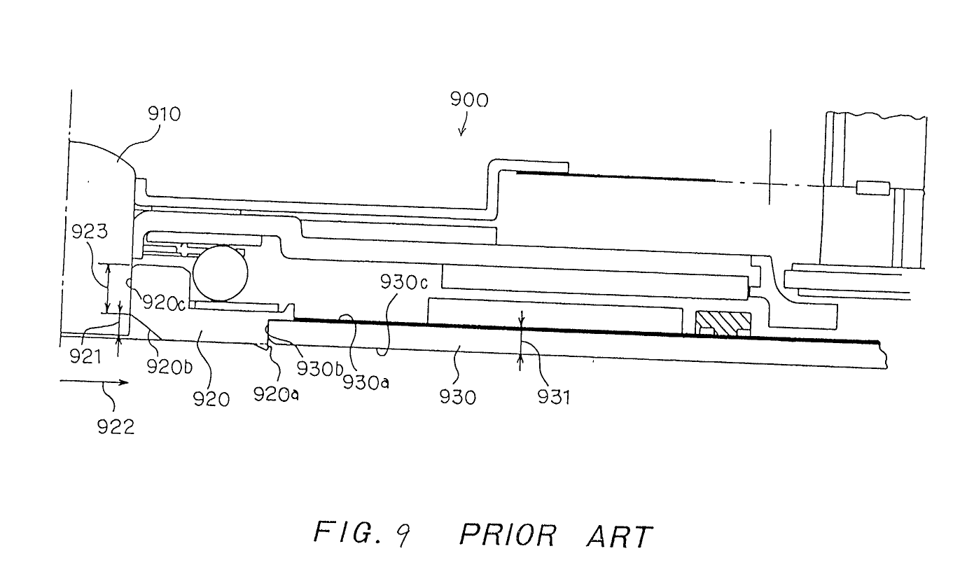

Disposed on the center of the cookie 410, as shown in FIG. 7, is the metal center core 450 made of a magnetic stainless steel (SUS 430). The metal center core 450 has a square positioning hole 450a into which the spindle 120 is inserted and a rectangular drive hole 450b in which the drive pin 191 is fitted for turning the cookie 410.

The installation of the radial bearing 130 in the printed-circuit board 110 is, as shown in FIG. 3, accomplished by fitting the disk portion 130b into the mount hole 110a in the printed-circuit board 110 and forcing the protrusion 130c outwardly against the bottom of the printed-circuit board 110 using a spin staking machine until the protrusion 130c enters an annular cavity formed between the round surface 110b and the periphery of the disk portion 130b so that the bottom 130g of the radial bearing 130 may be flush with the bottom 110c of the printed-circuit board 110. The forcing of the protrusion 130c against the printed-circuit board 110 will cause the disk portion 130b to bulge and engage the inner periphery of the mount hole 110a tightly.

The radial bearing 130 has, as described above, the annular slit 130f formed between the protrusion 130c and the bearing wall 130a. The annular slit 130f works to absorb the stress produced by plastic deformation of the disk portion 130b resulting from the staking of the protrusion 130c on the printed-circuit board 110, thus avoiding transmission of the stress to the bearing wall 130a. Specifically, the bearing wall 130a is not deformed when the protrusion 130c is staked on the printed-circuit board 110 to establish secure attachment of the radial bearing 130 to the printed-circuit board 110. This eliminates the need for sizing the bearing wall 130a after the radial bearing 130 is installed in the printed-circuit board 110.

FIG. 8 shows a relation between a decrease in inner diameter 131 of the bearing wall 130a (i.e., an amount of deformation of the bearing wall 130a) and the height of the protrusion 130c to be deformed plastically by the staking for different depths of the slit 130f obtained by tests performed using a spin staking machine US-1 produced by Yoshikawa Tekkou Co., Ltd in Japan. In the tests, an air pressure of approximately 3000 Pa (3 kg/cm²) is supplied to an air cylinder of the spin staking machine. Note that it is found that the width of the slit 130f does not contribute to a change in inner diameter of the bearing wall 130a at all.

Note that in order to ensure a desired strength of attachment of the disk portion 130b to the printed-circuit board 110, a 60 μm minimum height of the protrusion 130c is required. The graph of FIG. 8, thus, shows that when the depth of the slit 130f is greater than 0.5 mm that is the thickness of the printed-circuit board 110, it is possible to decrease a change in inner diameter 131 of the bearing wall 130a below 1 μm which eliminates adverse effects of the elastic deformation of the protrusion 130c on the bearing wall 130a substantially.

The deeper the slit 130f, the smaller will be the decrease in inner diameter 131 of the bearing wall 130a. When the depth of the slit 130f is, as indicated by lower two of the lines of FIG. 8, greater than or equal to 0.5 mm that is the thickness of the printed-circuit board 110, a change in inner diameter 131 of the bearing wall 130a will be decreased greatly. Specifically, when the depth of the slit 130f is greater than or equal to the thickness of the printed-circuit board 110, slight errors in staking operation, i.e., a small change in staked amount of the protrusion 130b hardly impinges upon a change in inner diameter 131 of the bearing wall 130a. This will result in ease of production processes of the spindle motor 100, thus allowing the manufacturing costs to be decreased.

The graph of FIG. 8 also shows that the deeper the slit 130f, the greater will be the height of the protrusion 130c which initiates decreasing of the inner diameter 131 of the bearing wall 130a. This results in ease of adjustment and control of a stroke of the staking machine.

The axial deflection of the spindle 120 of the spindle motor 100 will be described below in detail.

The spindle 120 is, as clearly shown in FIG. 3, press-fitted in the burring hole 140a formed in the center of the rotor yoke 140 without use of a fastening member such as such as a hub, thus resulting in formation of a relatively large space above the bearing wall 130a. This allows the bearing span 132 of the bearing wall 130a sufficient for minimizing the axis deflection of the spindle 120 to be ensured.

Further, the thrust bearing 150 is disposed outside the bearing wall 130a, and a plane on which the balls 153 are arrayed is located between upper and lower ends of the bearing wall 130a, thereby allowing the bearing span 132 of the bearing wall 130a to be increased sufficiently for decreasing the degree of deflection of the spindle 120 to a desired level.

The spindle motor 100 is, as described above, of an axial-gap type in which a great thrust is produced. The thrust bearing 150 works to take that thrust. The thrust bearing 150 has disposed therein the balls 153 and is subjected to rolling friction therein. Therefore, even if the pitch circle diameter of the balls 153 is increased, a torque loss, as expressed in an axial direction, will be very small. Specifically, even if it is impossible to provide a required value of the axial span 132, adjustment of an air gap between the outer periphery of the spindle 120 and the bearing wall 130a allows the axial deflection of the spindle 120 to be decreased.

When subjected to a lateral load, it will cause the spindle 120 of the spindle motor 100 to swing in a conical form symmetrically about the center of the arrays of balls 153. The center of each of the balls 153 is, as described above, located below the upper end of the bearing wall 130a, therefore, the bearing wall 130a takes at the upper and lower ends thereof the lateral load acting on the spindle 120, thereby resulting in an increase in service life of the spindle motor 100. Further, the bearing wall 130a also serves as a guide for use in assembling the spindle motor 100, thus resulting in improved efficiency of assembling of the spindle motor 100.

The printed-circuit board 110 working as a stator is made of a silicon steel, not iron, thereby resulting in a decrease in hysteresis loss of the spindle motor 100 to decrease the consumption of current. Tests were performed to compare the consumption of currents between this embodiment and a case where the stator is made of iron when no load is applied to the spindle motor 100. Test results showed that the consumption of current in this embodiment was lower by approximately 50 mA. Further, the silicon steel is usually lower in density than the iron. The printed-circuit board 110 is, thus, lighter than when it is made of iron, thereby resulting in a decrease in overall weight of the spindle motor 100.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments witch can be embodied without departing from the principle of the invention as set forth in the appended claims.

What is claimed is:

1. A spindle motor comprising:
a spindle;
a stator made of a magnetic metal plate on which an electric circuit is provided and in which a bearing mount hole is formed;
a radial bearing supporting said spindle in a radial direction thereof, said radial bearing including a mounting portion fitted within the bearing mount hole of said stator and a bearing wall taking a radial load acting on said spindle; and
a groove formed in said radial bearing between the mounting portion and the bearing wall.

2. A spindle motor as set forth in claim 1, wherein the magnetic metal plate is made of a non-oriented silicon steel plate.

3. A spindle motor as set forth in claim 1, wherein the magnetic metal plate has an edge of the bearing mount hole curved to define a recess between the edge and a periphery of the mounting portion of said radial bearing, and wherein the radial bearing has formed thereon a protrusion which is staked into the recess of the magnetic metal plate.

4. A spindle motor as set forth in claim 1, wherein a depth of said groove is greater than or equal to a thickness of said magnetic metal plate.

5. A spindle motor as set forth in claim 1, wherein said radial bearing is made of a copper-based oil impregnated metal.

6. A spindle motor as set forth in claim 1, further comprising a rotor having formed therein a hole in which said spindle is press-fitted directly.

7. A spindle motor as set forth in claim 6, further comprising a ball thrust bearing disposed outside the bearing wall of said radial bearing to take thrust acting thereon, and wherein the center of each ball of said ball thrust bearing is located between an upper and a lower end of said bearing wall.

8. A floppy disk device comprising:
a base plate; and
a spindle motor disposed on said base plate for rotating a floppy disk, said spindle motor including
(a) a spindle,
(b) a stator made of a magnetic metal plate on which an electric circuit is provided and in which a bearing mount hole is formed,
(c) a radial bearing supporting said spindle in a radial direction thereof, said radial bearing including a mounting portion fitted within the bearing mount hole of said stator and a bearing wall taking a radial load acting on said spindle, and
(d) a groove formed in said radial bearing between the mounting portion and the bearing wall.

9. A flopply disk device as set forth in claim 8, wherein the magnetic metal plate is made of a non-oriented silicon steel plate.

10. A floppy disk device as set forth in claim 8, wherein the magnetic metal plate has an edge of the bearing mount hole curved to define a recess between the edge and a periphery of the mounting portion of said radial bearing, and wherein the radial bearing has formed thereon a protrusion which is staked into the recess of the magnetic metal plate.

11. A floppy disk device as set forth in claim 8, wherein a depth of said groove is greater than or equal to a thickness of said magnetic metal plate.

12. A floppy disk device as set forth in claim 8, wherein said radial bearing is made of a copper-based oil impregnated metal.

13. A floppy disk device as set forth in claim 8, further comprising a rotor having formed therein a hole in which said spindle is press-fitted directly.

14. A floppy disk device as set forth in claim 13, further comprising a ball thrust bearing disposed outside the bearing wall of said radial bearing to take thrust acting thereon, and wherein the center of each ball of said ball thrust bearing is located between an upper and a lower end of said bearing wall.

15. A floppy disk device comprising:
a rotor;
a chuck disposed on said rotor;
a spindle press-fitted directly in said rotor;
a stator made of a magnetic metal plate on which an electric circuit is provided and in which a bearing mount hole is formed;
a radial bearing supporting said spindle in a radial direction thereof, said radial bearing including a mounting portion fitted within the bearing mount hole of said stator and a bearing wall taking a radial load acting on said spindle; and
a groove formed in said radial bearing between the mounting portion and the bearing wall.
